(19) United States
(12) Patent Application Publication
(10) Pub. No.: US 2026/0217968 A1
(43) Pub. Date: Jul. 30, 2026

(54) NOVEL COMPATIBILIZER COMPOSITIONS AND BLENDS THEREOF

(71) Applicant: Lumas Polymers LLC., Chaska, MN (US)

(72) Inventors: Thomas Fry, Victoria, MN (US); John G. Eue, St. Louis Park, MN (US)

(21) Appl. No.: 19/140,109

(22) PCT Filed: Dec. 14, 2023
(86) PCT No.: PCT/US2023/084074

§ 371 Date: Jun. 17, 2025

Related U.S. Application Data
(60) Provisional application No. 63/476,545, filed on Dec. 21, 2022.

(51) Int. Cl. C08L 69/00; C08L 55/02

(52) U.S. Cl. CPC C08L 69/00; C08L 55/02; C08L 2203/30; C08L 2205/025; C08L 2205/03; C08L 2205/035; C08L 2205/08

(57) ABSTRACT

A compatibilizer composition and thermoplastic blends thereof having improved impact properties and tensile properties are described herein. The compatibilizer composition consists of a non-reactive component and a reactive component selected to improve miscibility of the matrix resin components, as well as improve the physical properties of the resulting thermoplastic blend. Further, a method of improving the physical properties of a thermoplastic blend is described.

### FIELD

The present disclosure relate to materials and methods for improving the properties of polymeric material. More specifically, the present disclosure relates to a compatibilizer composition, and methods of using said compatibilizer composition, to improve the physical properties of thermoplastic resin including post-consumer resin.

### BACKGROUND OF THE INVENTION

Thermoplastics with high stiffness, high thermal stability, and balanced impact resistance are desirable for many industries including consumer electronics, automotive assemblies, and appliance housings. Polycarbonate blends, such as blends of polycarbonate (PC) and acrylonitrile butadiene-styrene (ABS), can provide desired properties for these applications. Due to the desirable properties of PC blends, such as PC-ABS, these materials have a high annual consumption, and thus contribute greatly to the staggering amount of plastic waste that haunts landfills worldwide.

While thermoplastics can be recycled, many post-consumer resins (PCRs) lose their mechanical properties over time, frequently due to degradation, and are thus landfilled, rather than recycled. Currently, the efforts to re-purpose PCRs include incorporating virgin thermoplastics with the PCR as well as incorporating impact modifiers to generate blends with improved impact resistance compared to un-modified PCR. There have been many attempts to efficiently reclaim and reuse PC/ABS at the end of its service life. However, products made from high recycled content typically have poor properties and blends with low recycled content do not consume enough waste material to slow the environmental impact of PC-ABS waste.

Improving the physical properties of thermoplastics, particularly PCRs, would not only provide material with desirable properties for a great many applications, but would also reduce the amount of post-consumer resin in landfills.

### SUMMARY

Accordingly, the present disclosure describes materials and methods for improving the physical properties of thermoplastic blends.

In one aspect, a compatibilizer composition for a thermoplastic blend is disclosed. The compatibilizer composition comprises: at least one reactive component, and at least one non-reactive component. The compatibilizer composition is configured to modify a matrix resin comprising a first component with a first solubility parameter and a second component with a second solubility parameter; and wherein a solubility parameter of the reactive component is between the first solubility parameter and the second solubility parameter.

In some embodiments of the first aspect, at least one reactive component of the compatibilizer composition comprises acrylonitrile-styrene-acrylate and maleic anhydride copolymer. In some embodiments of the first aspect, at least one reactive component of the compatibilizer composition comprises acrylonitrile-styrene-acrylate and glycidyl methacrylate copolymer.

In some embodiments of the first aspect, the at least one non-reactive component of the compatibilizer composition comprises ethyl methacrylate. In some embodiments of the first aspect, the at least one non-reactive component of the compatibilizer composition comprises ethyl butyl acrylate. In some embodiments of the first aspect, the at least one non-reactive component of the compatibilizer composition comprises a non-reactive silicone-acrylic rubber.

In some embodiments of the first aspect, the ratio of the at least one reactive component to the at least one non-reactive component in the compatibilizer composition is from 1:2.3 to 2.3:1.

In some embodiments of the first aspect, the at least one reactive component comprises acrylonitrile-styrene-acrylate and maleic anhydride copolymer and the at least one non-reactive component comprises ethyl methacrylate.

In some embodiments of the first aspect, the at least one reactive component is acrylonitrile-styrene-acrylate and maleic anhydride copolymer and the non-reactive component is ethyl butyl acrylate.

In some embodiments of the first aspect, the at least one reactive component comprises acrylonitrile-styrene-acrylate and glycidyl methacrylate copolymer and the at least one non-reactive component comprises ethyl methacrylate.

In some embodiments of the first aspect, the at least one reactive component comprises acrylonitrile-styrene-acrylate and glycidyl methacrylate copolymer and the at least one non-reactive component comprises ethyl butyl acrylate.

In some embodiments of the first aspect, the at least one reactive component comprises acrylonitrile-styrene-acrylate and glycidyl methacrylate copolymer and acrylonitrile-styrene-acrylate and maleic anhydride copolymer; and the at least one non-reactive component comprises ethyl methacrylate.

In some embodiments of the first aspect, the at least one reactive component comprises acrylonitrile-styrene-acrylate and glycidyl methacrylate copolymer and acrylonitrile-styrene-acrylate and maleic anhydride copolymer; and the at least one non-reactive component comprises a non-reactive silicone-acrylic rubber.

In a second aspect, a thermoplastic blend is disclosed. The thermoplastic blend comprising: a matrix resin, wherein the matrix resin comprises a first component and a second component, and the compatibilizer composition according to the first aspect described above.

In some embodiments of the second aspect, the matrix resin comprises a post-consumer resin. In some embodiments of the second aspect, the matrix resin comprises polycarbonate. In some embodiments of the second aspect, the matrix resin comprises polycarbonate and acrylonitrile butadiene-styrene.

In some embodiments of the second aspect, the matrix resin comprises from 50 weight % to 80 weight % polycarbonate based on the total weight of the thermoplastic blend.

In some embodiments of the second aspect, the thermoplastic comprises from 3 weight % to 7 weight % of the compatibilizer composition, based on the total weight of the thermoplastic blend.

In some embodiments of the second aspect, the at least one reactive component comprises acrylonitrile-styrene-acrylate and maleic anhydride copolymer. In some embodiments of the second aspect, the at least one reactive component comprises acrylonitrile-styrene-acrylate and glycidyl methacrylate copolymer.

In some embodiments of the second aspect, the at least one non-reactive component comprises ethyl methacrylate. In some embodiments of the second aspect, the at least one non-reactive component comprises ethyl butyl acrylate. In some embodiments of the second aspect, the at least one non-reactive component comprises a non-reactive silicone-acrylic rubber.

In some embodiments of the second aspect, the compatibilizer composition comprises a ratio of the at least one reactive component to the at least one non-reactive component is from 1:2.3 to 2.3:1.

In a third aspect, a method of improving the physical properties of a thermoplastic blend is disclosed. The method comprises adding the compatibilizer composition according to the first aspect described above to a matrix resin to obtain a thermoplastic blend with improved physical properties.

In some embodiments of the third aspect, the at least one reactive component comprises acrylonitrile-styrene-acrylate and maleic anhydride copolymer. In some embodiments of the third aspect, the at least one reactive component comprises acrylonitrile-styrene-acrylate and glycidyl methacrylate copolymer.

In some embodiments of the third aspect, the at least one non-reactive component comprises ethyl methacrylate. In some embodiments of the third aspect, the at least one non-reactive component comprises ethyl butyl acrylate. In some embodiments of the third aspect, the at least one non-reactive component comprises a non-reactive silicone-acrylic rubber.

In some embodiments of the third aspect, the ratio of the at least one reactive component to the at least one non-reactive component is from 1:2.3 to 2.3:1.

In some embodiments of the third aspect, the at least one reactive component comprises acrylonitrile-styrene-acrylate and maleic anhydride copolymer and the at least one non-reactive component comprises ethyl methacrylate.

In some embodiments of the third aspect, the at least one reactive component is acrylonitrile-styrene-acrylate and maleic anhydride copolymer and the non-reactive component is ethyl butyl acrylate.

In some embodiments of the third aspect, the at least one reactive component comprises acrylonitrile-styrene-acrylate and glycidyl methacrylate copolymer and the at least one non-reactive component comprises ethyl methacrylate.

In some embodiments of the third aspect, the at least one reactive component comprises acrylonitrile-styrene-acrylate and glycidyl methacrylate copolymer and the at least one non-reactive component comprises ethyl butyl acrylate.

In some embodiments of the third aspect, the at least one reactive component comprises acrylonitrile-styrene-acrylate and glycidyl methacrylate copolymer and acrylonitrile-styrene-acrylate and maleic anhydride copolymer; and the at least one non-reactive component comprises ethyl methacrylate.

In some embodiments of the third aspect, the at least one reactive component comprises acrylonitrile-styrene-acrylate and glycidyl methacrylate copolymer and acrylonitrile-styrene-acrylate and maleic anhydride copolymer; and the at least one non-reactive component comprises a non-reactive silicone-acrylic rubber.

In some embodiments of the third aspect, the matrix resin comprises a post-consumer resin. In some embodiments of the third aspect, the matrix resin comprises polycarbonate. In some embodiments of the third aspect, the matrix resin comprises polycarbonate and acrylonitrile butadiene-styrene. In some embodiments of the third aspect, the matrix resin comprises from 50 weight % to 80 weight % polycarbonate based on the total weight to the thermoplastic blend.

In some embodiments of the third aspect, the thermoplastic comprises from 3 weight % to 7 weight % of the compatibilizer composition, based on the total weight of the thermoplastic blend.

This summary is intended to be non-limiting on the scope of the present invention. Additional features and advantages will become apparent from the following detailed description when taken in conjunction with the accompanying drawings.

### BRIEF DESCRIPTION OF THE DRAWINGS

The drawings described herein are for illustrative purposes for selected embodiments and not all possible implementations, and are not intended to limit the scope of the present disclosure.

FIG. 1 is a representative chart illustrating the impact properties of thermoplastic blends, in accordance with an embodiment of the present invention.

FIG. 2 is a representative chart illustrating the impact properties of thermoplastic blends, in accordance with an embodiment of the present invention.

FIG. 3 is a representative chart illustrating the elasticity properties of thermoplastic blends, in accordance with an embodiment of the present invention.

FIG. 4 is a representative chart illustrating the tensile strength of the thermoplastic blends, in accordance with an embodiment of the present invention.

FIG. 5 is a representative chart illustrating the elongation properties in thermoplastic blends, in accordance with an embodiment of the present invention.

FIG. 6 is a representative chart illustrating the elasticity properties of thermoplastic blends, in accordance with an embodiment of the present invention.

FIG. 7 is a representative chart illustrating the tensile strength of thermoplastic blends, in accordance with an embodiment of the present invention.

FIG. 8 is a representative chart illustrating the impact strength in thermoplastic blends at low temperature, in accordance with an embodiment of the present invention.

FIG. 9 is a representative chart illustrating the impact properties of thermoplastic blends having post-consumer resin and post-industrial resin, in accordance with an embodiment of the present invention.

FIG. 10 is a representative chart illustrating the impact properties of thermoplastic blends having post-industrial resin, in accordance with an embodiment of the present invention.

### DETAILED DESCRIPTION OF EMBODIMENTS OF THE INVENTION

The figures and descriptions provided herein may have been simplified to illustrate aspects that are relevant for a clear understanding of the herein described materials, compositions, and methods, while eliminating, for the purpose of clarity, other aspects that may be found in typical similar materials, compositions, and methods. Those of ordinary skill may thus recognize that other elements and/or operations may be desirable and/or necessary to implement the materials, compositions, and methods described herein. But because such elements and operations are known in the art, and because they do not facilitate a better understanding of the present disclosure, for the sake of brevity a discussion of such elements and operations may not be provided herein. However, the present disclosure is deemed to nevertheless include all such elements, variations, and modifications to the described aspects that would be known to those of ordinary skill in the art.

Regarding methods disclosed, the order of the steps presented is illustrative in nature, and thus, the order of the steps may be different in various embodiments. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

The term “or” as used herein, with respect to a list of two or more items, elements, components, or materials, is not indicative of a complete disjunction such that the listed items, elements, components, or materials are mutually exclusive of each other. For example, “X, Y, or Z” does not mean that each of X, Y, Z are mutually exclusive of each other. Two or more of X, Y, Z could partially or completely overlap each other or that at least one of X, Y, or Z could be included in or be a subgenus of at least one of another of X, Y, or Z.

Although the open-ended term “comprising,” as a synonym of non-restrictive terms such as including, containing, or having, is used herein to describe and claim embodiments, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within the ranges as if each numerical value and sub-range is explicitly recited. As an illustration, a numerical range of “about 1 to 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc. as well as 1, 2, 3, 4, and 5, individually. The same principle applies to ranges reciting only one numerical value as a minimum or a maximum. Furthermore, such an interpretation should apply regardless of the breadth of the range or the characteristics being described.

As used herein, the term “thermoplastic” is used to refer to any material capable of softening, or fusing, upon application of heat and setting, or hardening, upon cooling. Examples of thermoplastics include polycarbonate or PC, polyethylene or PE, acrylic, polyamide or PA (also known as nylon), polymethylmethacrylate or PMMA, polystyrene or PS, polypropylene or PP, acrylonitrile butadiene styrene or ABS, acrylonitrile styrene-acrylic or ASA, polyester, poly(vinyl chloride) or PVC, polyethylene terephthalate (PET), polybutylene terephthalate (PBT), polytetrafluoroethylene or PTFE (also known as teflon), blends thereof, and derivatives thereof. Thermoplastic polycarbonate blends include, but are not limited to: polycarbonate/acrylonitrile butadiene styrene (PC-ABS), polycarbonate/methylmethacrylate acrylonitrile butadiene styrene (PC-MABS) polycarbonate/styrene acrylonitrile (PC-SAN), polycarbonate/polyethylene terephthalate (PC-PETP), polycarbonate/polybutylene terephthalate (PC-PBT), polycarbonate/polyethylene (PC-PE), polycarbonate/poly(vinylchloride) (PC-PVC), polycarbonate/polyurethane (PC-PUR), polycarbonate/poly(methylmethacrylate) (PC-PMMA), polycarbonate/acrylonitrile styrene-acrylic (PC-ASA), and polycarbonate/polystyrene (PC-PS).

As used herein, the term “post-consumer resin” is defined as polymeric resin obtained from post-consumer recycled content, that is finished goods that are used and then recycled. As used herein, the term “post-industrial resin” is defined as polymeric resin obtained from post-industrial waste, that is waste generated from the manufacturing process. The two terms will be used interchangeably throughout the specification.

As is already known in the art, additives, such as impact modifiers, may be combined with post-consumer resins in an effort to re-gain many of the mechanical properties of the virgin resin. As an example, PCR polycarbonate/acrylonitrile butadiene-styrene (PC-ABS) is modified via the incorporation of functionalized block copolymers. Examples of modifiers include maleic anhydride grafted styrene-ethylene-butylene-styrene, or SEBS-MAH, which provides a polycarbonate reactive MAH block and an ABS compatible styrenic block resulting in a thermoplastic blend with a somewhat greater toughness than post-consumer PC-ABS. Additional modifiers include combinations of reactive and non-reactive modifiers to improve dispersion and domain size of the modifying particles; examples include: glycidyl methacrylate functionalized ethylene methacrylate (EMA-GMA), also known by the commercial name Lotader®; and non-functionalized ethylene methacrylate (EMA), also known by the commercial name Lotryl®.

In the case of reactive/non-reactive modifier combinations the surface energy and solubility parameter of the polymers drive the increase in blend properties. The reactive species dispersed in the blend due to the covalent linkages generated between the modifier and polycarbonate. The non-reactive species is not miscible with the PC/ABS and therefore works to diffuse into the domains of reactive modifiers. This conservation of surface energy is the driving force of domain growth which provides the improvement of impact properties.

The compatibility of components can be determined by utilizing Hildebrand solubility parameters using Equation 1 below. This equation demonstrates that a polymers solubility parameter is a function of its molar attraction constant (F) divided by its molar volume (V). These attraction constants and volumes can be determined using group contribution theory. Group contribution theory allows one to break down a polymers repeat units into discrete functional groups that possess well defined attraction constants and volumes. The summation of these groups allows for the determination of a polymers solubility parameter.

$$δ = \frac{{\sum }_{i} {F}_{1}}{V} \qquad ( Equation 1 )$$

Compatibility of polymers can be determined by comparing their solubility parameters. As a general rule, if the difference between two polymers solubility parameters is less than or equal to one, the blend is miscible. If the difference is greater than one, it can be assumed that the blend is incompatible. Of course, there are exceptions to this rule based on specific interactions that can improve miscibility such as pi-pi complexes that can be found between the benzene rings of styrene units in ABS and the aromatic rings of bisphenol A in polycarbonate. Table 1 lists the solubility parameters calculated using Equation 1.

TABLE 1

| | Solubility |
|---|---|
| Polymer | Parameter (MPa^{1/2}) |
| Polycarbonate or PC | 21.7 |
| Acrylonitrile butadiene-styrene or ABS | 19.6 |
| Methylmethacrylate acrylonitrile butadiene styrene (MABS) | 17.2 |
| Glycidyl methacrylate functionalized ethylene methacrylate or EMA- | 16.2 |
| GMA | |
| Ethylene methacrylate or EMA | 16.4 |
| Maleic anhydride grafted styrene-ethylene-butylene-styrene or SEBS- | 17.1 |
| g-MAH | |
| Acrylonitrile styrene acrylate or ASA | 20.2 |
| Ethylene butyl acrylate or EBA | 16.8 |
| Glycidyl methacrylate functionalized ethylene butyl acrylate or EBA- | 18.9 |
| GMA | |
| Styrene-ethylene-butadiene-styrene or SEBS | 17.8 |
| Maleic anhydride functionalized acrylonitrile-styrene-acrylonitrile or | 21.0 |
| ASA-MAH | |
| Glycidyl methacrylate functionalized acrylonitrile-styrene-acrylonitrile | 20.1 |
| or ASA-GMA | |

As seen in Table 1, PC has a solubility parameter of 21.7 MPa^{1/2} and ABS has a value of 19.6 MPa^{1/2}. The difference in these values is 2.1 MPa^{1/2}, confirming the known immiscibility between PC and ABS. It can also be found that EMA, and its reactive derivative EMA-GMA, both have solubility parameters in the low 16 MPa^{1/2} range, this would lead one to believe that it would not be compatible with either component of the PC/ABS blends. While the vast difference in the solubility parameters between modifier and matrix would lead one to expect a reduction in properties, quite the opposite is observed. The notched Izod impact properties of several PC/ABS blends with various modifiers were evaluated. A thermoplastic blend comprising PCR PC-ABS 70/30 modified with 7.5% of a composition comprising 30% EMA-GMA and 70% EMA has an uninstrumented linear resilience of approximately 627 which outperforms a thermoplastic blend comprising PCR PC-ABS 70/30 modified with 7.5% SEBS-MAH with a linear resilience of approximately 530. This demonstrates the ability of the reactive species, in this case EMA-GMA, to disperse well with the PC and grow in size to improve the impact strength due to the similarity in solubility parameter between reactive and non-reactive modifiers.

While impact strength does improve significantly compared to purely reactive modifiers, the tensile properties do suffer. The tensile properties of these same blends were evaluated. The same thermoplastic blend comprising PCR PC-ABS 70/30 and the combination of EMA-GMA and EMA that provided excellent impact performance has substandard tensile properties, with an ultimate tensile strength of 46.1. The tensile modulus is roughly 200 MPa under what would be expected, the ultimate tensile strength is roughly 10 MPa less than normal, and the elongation is 8.3%, far below the expected value of 50%.

The suspected cause for the undesirable tensile properties is the incompatibility of the EMA based modifiers with ABS. The reactive EMA-GMA species is only reactive with the polycarbonate portion of the PC/ABS blend. As such, the non-reactive EMA will attempt to seek domains inside of the PC phase and will not toughen the ABS portion. While the PC domains will experience increased impact performance, any “free” EMA that was not able to migrate to a reactive EMA domain will reside at the interface of PC and ABS, weakening its adhesion. This accounts for the extreme loss in elongation and softening of other tensile properties.

To overcome the loss in tensile properties, it was theorized that reducing the difference in solubility parameter between the modifiers and matrix resins could improve compatibility and therefore physical properties.

The compatibilizer compositions described herein, for the purpose of improving not only impact properties but also tensile properties, comprise a reactive component with a solubility parameter that lies between the solubility parameters of the two immiscible polymers of the thermoplastic blend. Based on the solubility parameters listed in Table 1, it can be seen that acrylonitrile-styrene-acrylate (ASA) would be expected to be miscible with both PC and ABS due to the similarity in solubility parameter. The compatibilizer composition further comprises a non-reactive component. As the acrylate component of ASA is often methyl acrylate or butyl acrylate, ethylene methacrylate (EMA) or ethylene butyl acrylate (EBA) will serve well as a non-reactive component. In some embodiments, the reactive component of the compatibilizer composition comprises ASA. Additionally, or alternatively, the reactive component of the compatibilizer composition is ASA-MAH. In other embodiments, the reactive component of the compatibilizer compositions is ASA-GMA. Additionally, or alternatively, the reactive component may be a combination of ASA-GMA and ASA-MAH. In some embodiments, ASA-GMA comprises from about 1% to about 10% GMA. Additionally, or alternatively, ASA-GMA may comprise from about 3% to about 5% GMA. In some embodiments, ASA-MAH comprises from about 1% to about 10% MAH. Additionally, or alternatively, ASA-MAH may comprise from about 3% to about 5% MAH. Non-limiting examples of reactive components are listed in Table 2.

In some embodiments, the non-reactive component of the compatibilizer composition may be an acrylate. In some embodiments, the non-reactive component is EMA. Additionally, or alternatively, the non-reactive component is EBA. Additionally, or alternatively, the non-reactive component may be a non-reactive silicone-acrylic rubber. Although acrylates are described herein, it should be understood that other non-reactive impact modifiers may be used as the non-reactive component of the compatibilizer. Non-limiting examples of non-reactive components are listed in Table 2.

TABLE 2

| Reactive Component | Non-Reactive Component |
|---|---|
| ASA-MAH | EMA such as Lotryl ® |
| | 28MA07 |
| ASA-GMA | EBA such as Lotryl ® 35BA40 |
| ASA-GMA and ASA-MAH | Non-reactive silicone-acrylic |
| | rubber such as Metablen ™ S- |
| | 2030 |

The compatibilizer composition may comprise between 25% and 85% by weight non-reactive component. Additionally, the compatibilizer composition may comprise between 25% and 85% by weight reactive component. In some embodiments, the reactive component to non-reactive component ratio is 1:2.3. In some embodiments, the reactive component to non-reactive component ratio is 1:1.5. In some embodiments, the reactive component to non-reactive component ratio is 1:1. In some embodiments, the reactive component to non-reactive component ratio is 1.5:1. In some embodiments, the reactive component to non-reactive component ratio is 2.3:1.

The compatibilizer composition may be added as a modifier resin to a matrix resin to obtain a thermoplastic blend with improved physical properties. The compatibilizer composition may be added to a matrix resin at about 1% to about 20%. Alternatively, the compatibilizer composition may be added to a matrix resin at about 1% to about 10%. In some embodiments, the compatibilizer composition is added to a matrix resin at about 3% to about 7%.

In some embodiments, the compatibilizer composition is added to a post-consumer resin (PCR) to improve the physical properties of the PCR. By improving the physical properties of the PCR the PCR may be re-purposed. This would reduce the amount of PCR that ends up in landfills. Additionally, or alternatively, the compatibilizer composition is added to virgin resins to improve physical properties to make engineering resins with greater physical properties.

In some embodiments, the compatibilizer composition is added to a thermoplastic blend. In some embodiments, the compatibilizer composition is added to a polycarbonate blend. In some embodiments, the compatibilizer is added to a polycarbonate blend comprising 90% PC. Additionally, or alternatively, the compatibilizer composition is added to a polycarbonate blend comprising 80% PC. In some embodiments, the compatibilizer composition is added to a polycarbonate blend comprising 70% PC. In other embodiments, the compatibilizer composition is added to a polycarbonate blend comprising 60% PC. In other embodiments, the compatibilizer composition is added to a polycarbonate blend comprising 50% PC. In some embodiments, the compatibilizer composition is added to a polycarbonate blend comprising PC-ABS.

The compatibilizer composition may be added to a matrix resin to obtain a thermoplastic blend with a greater impact strength. Additionally, or alternatively, the compatibilizer composition may be added to a matrix resin to obtain a thermoplastic blend with an improved elasticity, or modulus of elasticity. In some embodiments, the compatibilizer composition may be added to a matrix resin to obtain a thermoplastic blend with an improved tensile strength, or ultimate tensile strength (UTS). Additionally, or alternatively, the compatibilizer may be added to a matrix resin to obtain a thermoplastic blend with an improved elongation at break (EAB).

### WORKING EXAMPLES

In the below working examples, compatibilizer compositions were added to various PC/ABS blends. Compatiblizer compositions include 30% reactive component and 70% non-reactive component. In the case where there are two reactive components, they are each added at 15% of the compatibilizer composition. The PC/ABS formulations were compounded using a Leistritz ZSE 27MAXX co-rotating intermeshed twin screw extruder with L/D ratio of 40/1. All constituents of the formulas were fed in at the feed throat using a loss in weight feeder. The screw speed of the extruder was between 400 and 600 rpm and melt temperature was between 250 and 290 degrees Celsius. To evaluate mechanical properties ASTM D638 Type I tensile bars and ASTM D790 Flex bars were injection molded using a Milacron Roboshot S-2000i100A injection molder. Prior to molding the compounded pellets were dried to less than 0.02% moisture. The test coupons were molded at melt temperature of 490 to 530 degrees Fahrenheit and a mold temperature of 180 to 200 degrees Fahrenheit.

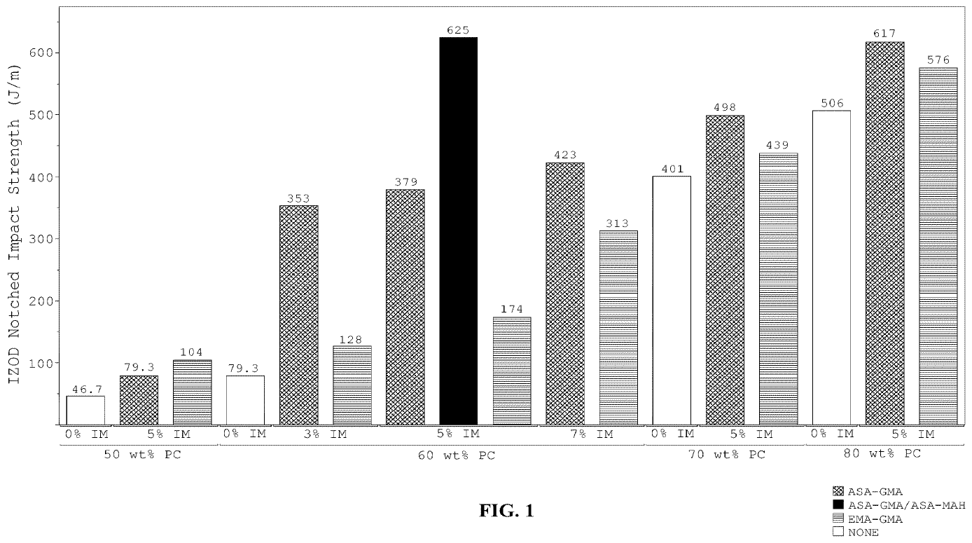

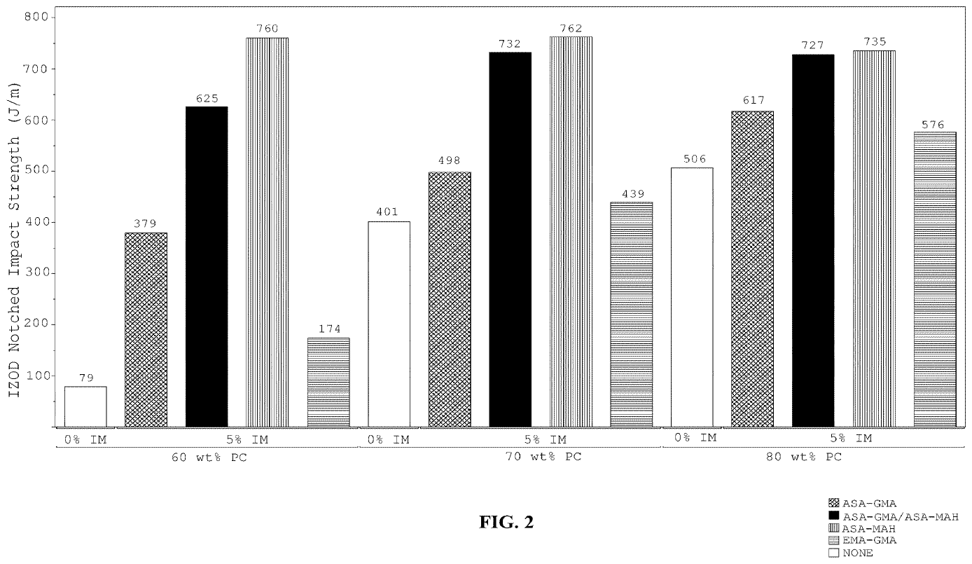

As shown in FIGS. 1 and 2, the addition of 5% compatibilizer composition to a 50/50 virgin PC-ABS blend increases the impact performance. Additionally, also shown in FIG. 1, when a compatibilizer composition is added to a 60/40 PC/ABS blend the impact performance is increased. Specifically, 3% ASA-GMA/EMA increases the impact performance from 79 J/m to 353 J/m, while 3% of the standard impact modifier EMA-GMA/EMA increases the impact performance from 79 J/m to 128 J/m. When 5% of the compatibilizer composition ASA-GMA/EMA is added to the PC-ABS blend the impact performance is further increased to 379 J/m, compared to the standard impact modifier EMA-GMA/EMA which only increases the impact performance to 166 J/m. More surprisingly, when 5% of a compatibilizer composition containing ASA-GMA/ASA-MAH/EMA improves the impact performance to 352 J/m. The results illustrated in FIGS. 1 and 2 are shown in Table 3. The impact testing data obtained in FIGS. 1 and 2 were obtained using ASTM D256 with an Instron Ceast 9050 Impact Testing Machine. Not shown in the drawings, when 7.5% SEBS-MAH/EMA is added to a 70% PC blend the impact resistance is 530 J/m.

TABLE 3

| | Compatibilizer Composition | | | |
|---|---|---|---|---|
| | Reactive | Non-Reactive | Percentage of | Impact |
| Percentage of | Component | Component | Compatibilizer | Performance |
| Polycarbonate | (30%) | (70%) | Composition | (J/m) |
| 50 | — | — | 0 | 46.7 |
| | ASA-GMA | EMA | 5 | 79.3 |
| | EMA-GMA | EMA | 5 | 104 |
| 60 | — | — | 0 | 79 |
| | ASA-GMA | EMA | 3 | 353 |
| | EMA-GMA | EMA | 3 | 128 |
| | ASA-GMA/ASA- | EMA | 5 | 625 |
| | MAH | | | |
| | ASA-MAH | EMA | 5 | 760 |
| | ASA-GMA | EMA | 5 | 379 |
| | EMA-GMA | EMA | 5 | 174 |
| | ASA-GMA | EMA | 7 | 423 |
| | EMA-GMA | EMA | 7 | 313 |
| 70 | — | — | 0 | 401 |
| | ASA-GMA | EMA | 5 | 498 |
| | EMA-GMA | EMA | 5 | 439 |
| | ASA-GMA/ASA- | EMA | 5 | 732 |
| | MAH | | | |
| | ASA-MAH | EMA | 5 | 762 |
| | SEBS-MAH | EMA | 7.5 | 530 |
| 80 | — | — | 0 | 506 |
| | ASA-GMA | EMA | 5 | 617 |
| | EMA-GMA | EMA | 5 | 576 |
| | ASA-GMA/ASA- | EMA | 5 | 727 |
| | MAH | | | |
| | ASA-MAH | EMA | 5 | 735 |

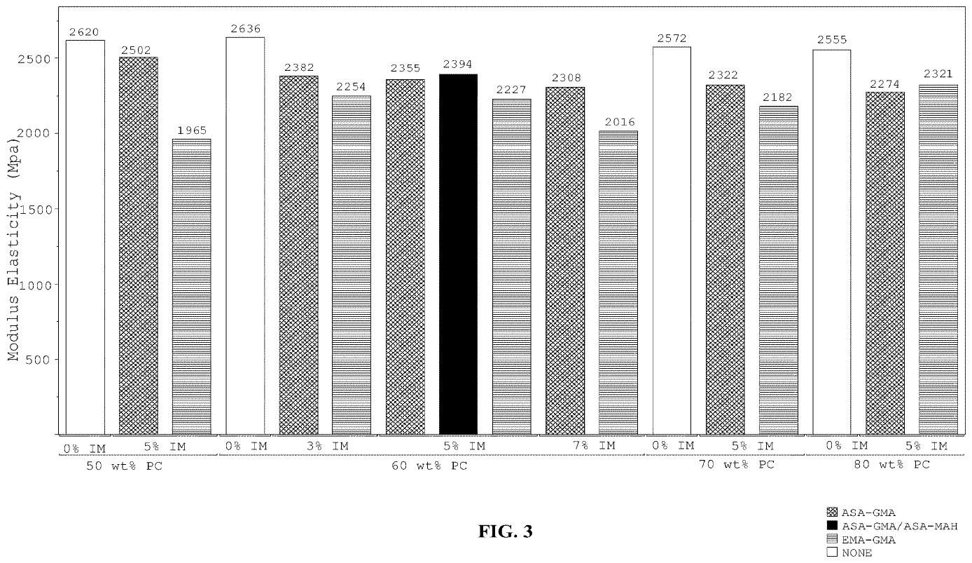

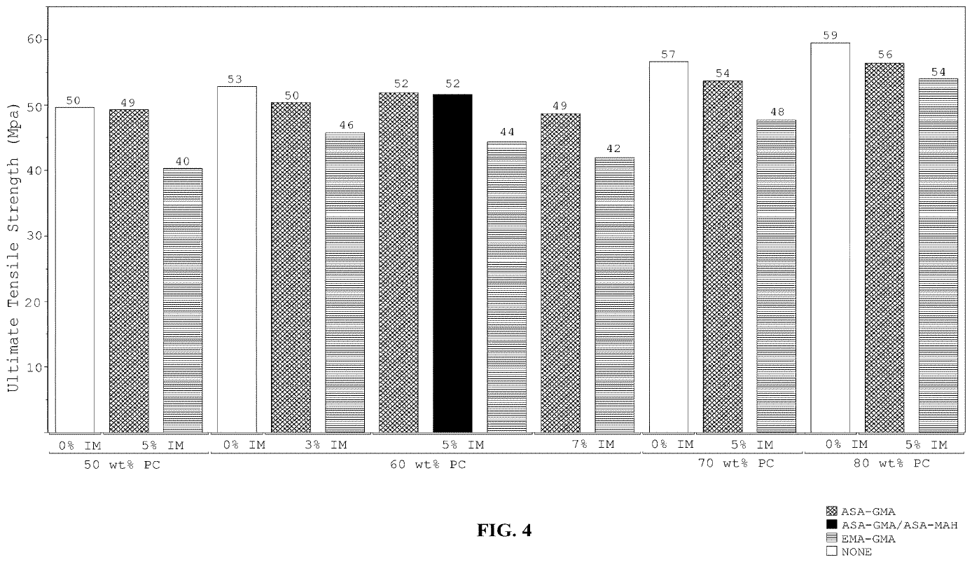

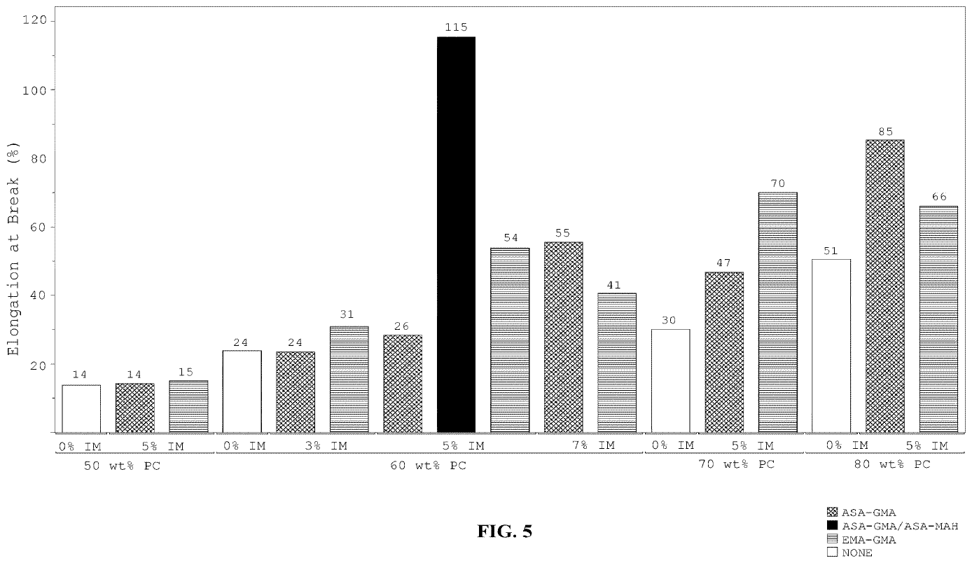

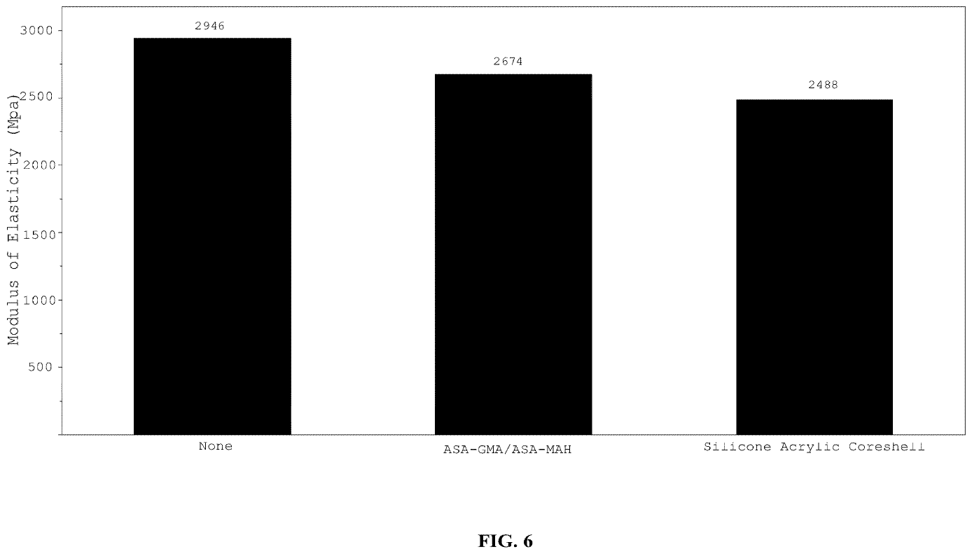

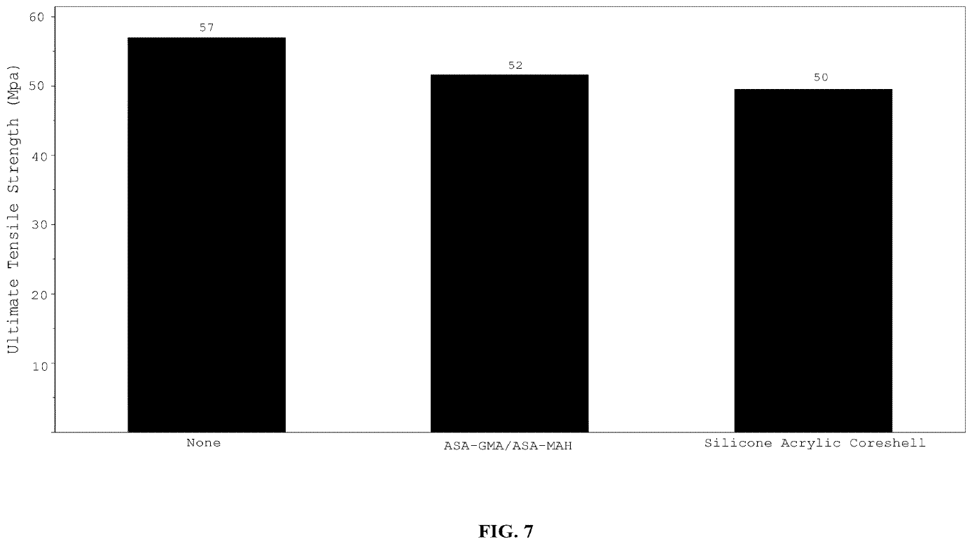

Additional properties of the modified virgin polycarbonate blends are illustrated in FIGS. 3-7. FIG. 3 illustrates the improved elasticity modulus upon the addition of the compatibilizer compositions described herein. FIG. 4 illustrates the improved tensile strength upon the addition of the compatibilizer compositions described herein. FIG. 5 illustrates the improved elongation at break (EAB) properties upon the addition of the compatibilizer compositions described herein. The improved properties are also listed in Table 4. FIG. 6 shows a measure of elasticity for a PC/ABS blend having 57% PC and 23% ABS. With no compatibilizer, the elasticity modulus is 2946 MPa. With 0.75% ASA-GMA/0.75% ASA-MAH as a reactive component and 3.5% of a non-reactive silicone-acrylic rubber as a non-reactive component (ASA-GMA/ASA-MAH), the elasticity modulus decreases to 2674 MPa. When 1.5% of an epoxy-reactive silicone-acrylic rubber as the reactive component and 3.5% of a non-reactive silicone acrylic rubber as the non-reactive component is added (Silicone Acrylic Coreshell), the elasticity modulus further decreases to 2488 MPa. FIG. 7 shows the tensile strength of the same samples from FIG. 6. The data from FIGS. 3-7 were obtained using ASTM D638 with an Instron 3360 Series Universal Testing System. Not shown in the drawings, when 7.5% SEBS-MAH/EMA is added to a 70% PC blend the elongation at break is 19%, Ultimate Tensile Strength is 50 MPa, and Elasticity Modulus is 2505 MPa.

TABLE 4

| | Compatibilizer | | | | | |
|---|---|---|---|---|---|---|
| | Composition | | | | | |
| | | Non- | | | | |
| | Reactive | Reactive | Percentage of | Elasticity | Tensile | |
| Percentage of | Component | Component | Compatibilizer | Modulus | Strength | EAB |
| Polycarbonate | (30%) | (70%) | Composition | (Mpa) | (MPa) | (%) |
| 50 | — | — | 0 | 2620 | 50 | 14 |
| | ASA-GMA | EMA | 5 | 2502 | 49 | 14 |
| | EMA-GMA | EMA | 5 | 1965 | 40 | 15 |
| 57 | — | — | — | 2946 | 57 | ND |
| | ASA- | Non- | 5 | 2674 | 52 | ND |
| | GMA/ASA- | reactive | | | | |
| | MAH | silicone- | | | | |
| | | acrylic | | | | |
| | | rubber | | | | |
| | Epoxy- | Non- | 5 | 2488 | 50 | ND |
| | reactive | reactive | | | | |
| | silicone- | silicone- | | | | |
| | acrylic | acrylic | | | | |
| | rubber | rubber | | | | |
| 60 | — | — | 0 | 2636 | 53 | 24 |
| | ASA-GMA | EMA | 3 | 2382 | 50 | 24 |
| | EMA-GMA | EMA | 3 | 2254 | 46 | 31 |
| | ASA- | EMA | 5 | 2394 | 52 | 115 |
| | GMA/ASA- | | | | | |
| | MAH | | | | | |
| | ASA-GMA | EMA | 5 | 2355 | 52 | 28 |
| | EMA-GMA | EMA | 5 | 2227 | 44 | 54 |
| | ASA-GMA | EMA | 7 | 2308 | 49 | 55 |
| | EMA-GMA | EMA | 7 | 2016 | 42 | 41 |
| 70 | — | — | 0 | 2572 | 57 | 30 |
| | ASA-GMA | EMA | 5 | 2322 | 54 | 47 |
| | EMA-GMA | EMA | 5 | 2182 | 48 | 70 |
| | SEBS-MAH | EMA | 7.5 | 2505 | 50 | 19 |
| 80 | — | — | 0 | 2555 | 59 | 51 |
| | ASA-GMA | EMA | 5 | 2274 | 56 | 85 |
| | EMA-GMA | EMA | 5 | 2321 | 54 | 66 |

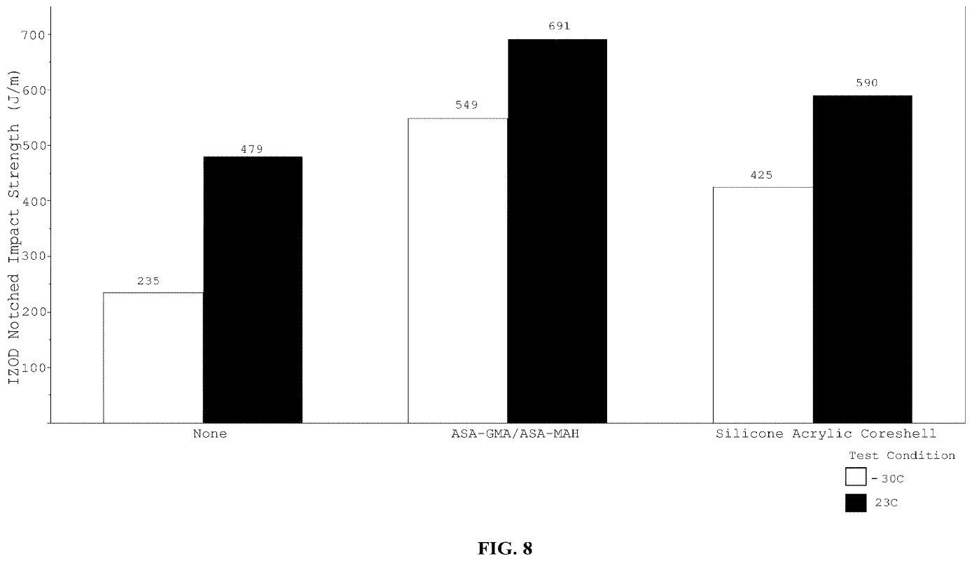

The compatibilizer compositions were further tested at low temperature. FIG. 8, shows the impact strength at −30° C. and 23° C. for a compatibilizer composition having: 0.75% ASA-GMA/0.75% ASA-MAH as a reactive component and 3.5% of a non-reactive silicone-acrylic rubber as a non-reactive component (labeled: ASA-GMA/ASA-MAH), and a compatibilizer composition having 1.5% of an epoxy-reactive silicone-acrylic rubber as the reactive component and 3.5% of a non-reactive silicone acrylic rubber as the non-reactive component (labeled: Silicone Acrylic Coreshell) each added to a PC/ABS blend having 57% PC and 23% ABS. Each of the compatibilizer compositions improve the impact strength over non-treated PC/ABS at both −30° C. and 23° C.

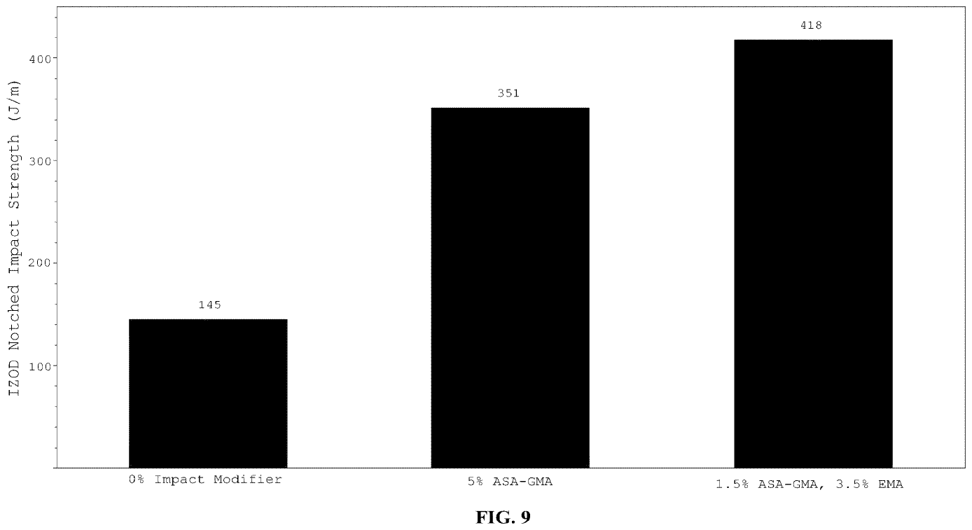

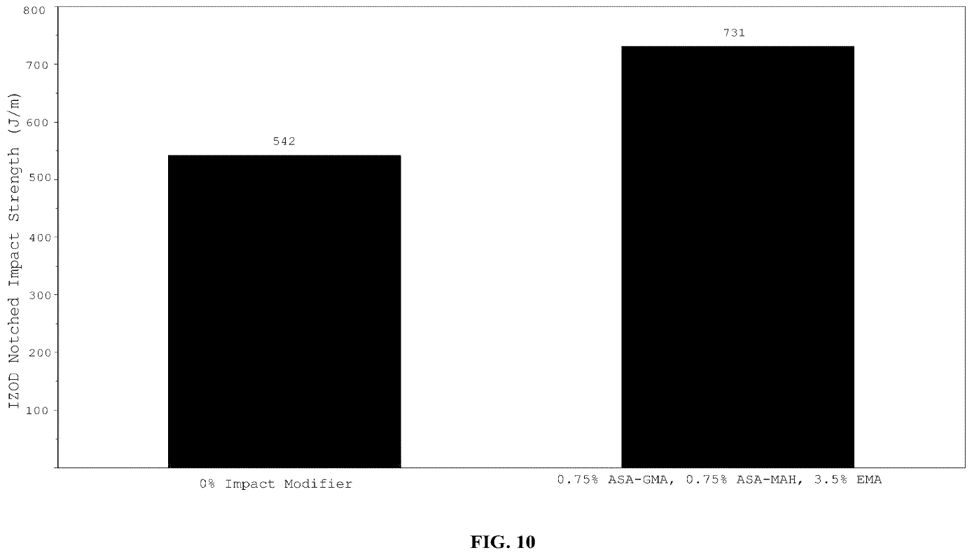

The compatibilizer compositions described herein were added to post-consumer resin and the impact performance was determined, as shown in Table 5, and FIGS. 9 and 10. The compatibilizer compositions described herein improve the impact performance of post-consumer resin (PCR) and post-industrial resin (PIR). As shown in FIG. 9, when no compatibilizer composition (or impact modifier) is added to PC/ABS made from 60% post-consumer resin and 40% post-industrial resin, the impact strength is 145 J/m. When a compatibilizer composition with only one component, ASA-GMA is added to the resin, the impact strength increases to 351. When a compatibilizer composition with two components, as described herein, is added the impact strength increases to 418 J/m. As shown in FIG. 10, when a compatibilizer composition, as described herein, is added to 100% post-industrial PC/ABS the impact strength increases to 731 from 542, compared to resin without a compatibilizer composition.

TABLE 5

| | Compatibilizer | Impact Performance |
|---|---|---|
| Resin | Composition | (J/m) |
| 100% PIR PC/ABS | — | 145 |
| 60% PCR 40% PIR | — | 542 |
| PC/ABS | | |
| 100% PIR PC/ABS | 5% ASA-GMA | 351 |
| 100% PIR PC/ABS | 1.5% ASA-GMA | 418 |
| | 3.5% EMA | |
| 60% PCR 40% PIR | 0.75% ASA-GMA | 731 |
| PC/ABS | 0.75% ASA-MAH | |
| | 3.5% EMA | |

It has been discovered that the utilization of a reactive polymer with a solubility parameter between two immiscible polymers in combination with a non-reactive impact modifier can improve the impact, tensile, and thermal properties of PC/ABS blends. Without being bound by theory, it could be assumed that the application of this reactive/non-reactive additive package to virgin PC/ABS blends could further improve the blends properties and allow it to expand into even more demanding applications. The compatibilizer compositions described herein may be used to modify virgin PC blends, as well as PCR or post-industrial resin (PIR) blends.

This test data shows that the ASA-GMA/ASA-MAH combination used for the reaction component of the compatibilizer composition shows much improved properties over non-modified PC-ABS blends and over the current standard EMA-GMA/EMA impact modifier. Without wishing to be bound by theory, it is believed that this is because the free carboxyl group created by the MAH graft is free to react with the free hydroxyl group formed by the GMA grafting to form a branched PC network.

The compatibilizer compositions described herein not only increase the impact performance of thermoplastic blends, but also reduce the standard deviation of the performance. When comparing tensile properties, it is seen that not only does the tensile strength and modulus return to prime material performance, but the elongation also jumps to nearly double that of commercially available grades.

The thermoplastic blends described herein may further comprise additional additives including but not limited to fire retardants. Examples of flame retardants include, but are not limited to, Nofia® CO6000 and Nofia® CO3000 (poly(phosphonate-co-carbonates), Phosgard® 600 (a non-halogenated phosphorous flame retardant), Phosgard® APP-MC (a melamine coated ammonium polyphosphate), Fyrolflex® Sol-DP (an oligomeric, free flowing solid pastilles phosphate ester flame retardant), Metablen™ S-2030 (a non-reactive silicone-acrylic rubber), and Metablen™ SX-005 (a silicone-acrylic rubber flame retardant).

In the foregoing detailed description, it may be that various features are grouped into individual embodiments for the purpose of brevity in the disclosure. This method of disclosure is not to be interpreted as reflecting an intention that any subsequently claimed embodiments require more features than are expressly recited.

Further, the descriptions of the disclosure are provided to enable any person skilled in the art to make or use the disclosed embodiments. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but rather is to be accorded the widest scope consistent with the principles and novel features disclosed herein.

1. A compatibilizer composition for a thermoplastic blend comprising:
at least one reactive component, and
at least one non-reactive component,
wherein the compatibilizer composition is configured to modify a matrix resin comprising a first component with a first solubility parameter and a second component with a second solubility parameter; and the reactive component reactive with the first component and has a reactive component solubility parameter between the first solubility parameter and the second solubility parameter.

2. The compatibilizer composition according to claim 1, wherein the at least one reactive component comprises acrylonitrile-styrene-acrylate and maleic anhydride copolymer; acrylonitrile-styrene-acrylate and glycidyl methacrylate copolymer; or a combination thereof.

3. The compatibilizer composition according to claim 1, wherein the at least one non-reactive component comprises ethyl methacrylate, ethyl butyl acrylate, a non-reactive silicone-acrylic rubber, or a combination thereof.

4. The compatibilizer composition according to claim 1, wherein the at least one reactive component to the at least one non-reactive component has a ratio from 1:2.3 to 2.3:1.

5. The compatibilizer composition according to claim 1, wherein the at least one reactive component comprises acrylonitrile-styrene-acrylate and maleic anhydride copolymer and the at least one non-reactive component comprises ethyl methacrylate.

6. The compatibilizer composition according to claim 1, wherein the at least one reactive component is acrylonitrile-styrene-acrylate and maleic anhydride copolymer and the non-reactive component is ethyl butyl acrylate.

7. The compatibilizer composition according to claim 1, wherein the at least one reactive component comprises acrylonitrile-styrene-acrylate and glycidyl methacrylate copolymer and the at least one non-reactive component comprises ethyl methacrylate.

8. The compatibilizer composition according to claim 1, wherein the at least one reactive component comprises acrylonitrile-styrene-acrylate and glycidyl methacrylate copolymer and the at least one non-reactive component comprises ethyl butyl acrylate.

9. The compatibilizer composition according to claim 1, wherein the at least one reactive component comprises acrylonitrile-styrene-acrylate and glycidyl methacrylate copolymer and acrylonitrile-styrene-acrylate and maleic anhydride copolymer; and the at least one non-reactive component comprises ethyl methacrylate.

10. The compatibilizer composition according to claim 1, wherein the at least one reactive component comprises acrylonitrile-styrene-acrylate and glycidyl methacrylate copolymer and acrylonitrile-styrene-acrylate and maleic anhydride copolymer; and the at least one non-reactive component comprises a non-reactive silicone-acrylic rubber.

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. A thermoplastic blend comprising:
a compatibilizer comprised of at least one reactive component and
at least one non-reactive component and
a matrix resin comprising a first component with a first solubility parameter and a second component with a second solubility parameter, wherein the reactive component has a reactive component solubility parameter is between the first solubility parameter and the second solubility parameter.

36. The thermoplastic blend of claim 35, wherein the reactive component comprises one or more of acrylonitrile-styrene-acrylate maleic anhydride copolymer and acrylonitrile-styrene-acrylate-glycidyl methacrylate copolymer.

37. The thermoplastic blend of claim 35, wherein the non-reactive component comprises one or more of ethyl methacrylate, ethyl butyl acrylate, and a non-reactive silicone-acrylic rubber.

38. The thermoplastic blend of claim 35, wherein the reactive component to the non-reactive component is a ratio from 1:2.3 to 2.3:1.

39. The thermoplastic blend of claim 35, wherein the non-reactive component is incompatible with the matrix resin.

40. The thermoplastic blend of claim 39, wherein the non-reactive component solubility parameter is less than first and second solubility parameter.

41. The thermoplastic blend of claim 40, wherein the non-reactive component has a non-reactive component solubility parameter that is greater than 1 different from the solubility parameter of the first and second solubility parameter.

42. (canceled)

43. (canceled)

44. (canceled)

45. (canceled)

46. (canceled)

47. The thermoplastic blend of claim 35, wherein the first component comprises polycarbonate and the second component is a polymer selected from one consisting of: acrylonitrile butadiene styrene copolymer; styrene acrylonitrile copolymer; polyethylene terephthalate, polybutylene terephthalate; polyethylene; poly(vinylchloride); polyurethane; poly(methylmethacrylate); acrylonitrile styrene-acrylic copolymer; polystyrene and combination thereof.

48. The thermoplastic blend of claim 47, wherein the second component is selected from a polymer consisting of: acrylonitrile butadiene styrene copolymer; styrene acrylonitrile copolymer; acrylonitrile styrene-acrylic copolymer; polystyrene and combination thereof.

49. The thermoplastic blend according to claim 47, wherein the matrix resin comprises from 50 weight % to 80 weight % polycarbonate based on the thermoplastic blend's weight.

50. (canceled)

51. (canceled)

52. (canceled)

53. (canceled)

54. (canceled)

55. (canceled)

56. (canceled)
